(19) United States
(12) Patent Application Publication
(10) Pub. No.: US 2023/0006799 A1
(43) Pub. Date: Jan. 5, 2023

(54) COMMUNICATION SYSTEM

(71) Applicant: Fraunhofer-Gesellschaft zur Foerderung der angewandten Forschung e.V., Munich (DE)

(72) Inventors: Baris GOEKTEPE, Berlin (DE); Cornelius HELLGE, Berlin (DE); Nithin SRINIVASAN, Berlin (DE); Thomas FEHRENBACH, Berlin (DE); Thomas SCHIERL, Berlin (DE); Thomas WIEGAND, Berlin (DE)

(21) Appl. No.: 17/843,779

(22) Filed: Jun. 17, 2022

Related U.S. Application Data
(63) Continuation of application No. PCT/EP2020/085596, filed on Dec. 10, 2020.

(30) Foreign Application Priority Data
Dec. 19, 2019 (EP) 19218278.0

(51) Int. Cl. H04L 5/00

(52) U.S. Cl. CPC H04L 5/0055

(57) ABSTRACT

Communication system including a data transmission controller, at least a transmitter and at least a receiver wherein the transmitter is configured to transmit a first data portion to the receiver by use of a resource portion having a bandwidth and a plurality of time frames in a manner to further increase a redundancy of the first data portion to be transmitted from time frame to time frame of the plurality of time frames, wherein the receiver is configured to analyze the received first data portion and its redundancy to determine a correctly and/or completely and/or sufficiently received first data portion or incorrectly and/or incompletely and/or insufficiently received first data portion and to transmit an ACK signal to the transmitter using the resource portion, when determining the correctly and/or completely and/or sufficiently received first data portion.

### CROSS-REFERENCE TO RELATED APPLICATIONS

This application is a continuation of copending International Application No. PCT/EP2020/085596, filed Dec. 10, 2020, which is incorporated herein by reference in its entirety, and additionally claims priority from European Application No. EP 19218278.0, filed Dec. 19, 2019, which is also incorporated herein by reference in its entirety.

Embodiments of the present invention refer to a communication system having a data transmission controller and to a corresponding method. Further embodiments refer to a gNB or eNB or access point or base station or a user equipment forming a transmitter of a communication system or forming a receiver of a communication system. Further embodiments refer to their corresponding methods. Embodiments of another aspect refer to a communication system having a resource controller. Another embodiment refers to the corresponding method. Another embodiment refers to a controller for a communication system, a transmitter of the communication system and their corresponding methods.

### BACKGROUND OF THE INVENTION

FIG. 1 is a schematic representation of an example of a terrestrial wireless network 100 including, as is shown in FIG. 1(a), a core network 102 and one or more radio access networks RAN₁, RAN₂, . . . RAN_{N}. FIG. 1(b) is a schematic representation of an example of a radio access network RAN_{D} that may include one or more base stations gNB₁ to gNB₅, each serving a specific area surrounding the base station schematically represented by respective cells 106₁ to 106₅. The base stations are provided to serve users within a cell. The term base station, BS, refers to a gNB in 5G networks, an eNB in UMTS/LTE/LTE-A/LTE-A Pro, an AP in IEEE 802.11, or just a BS in other mobile communication standards. A user may be a stationary device or a mobile device. The wireless communication system may also be accessed by mobile or stationary IoT devices which connect to a base station or to a user. The mobile devices or the IoT devices may include physical devices, ground based vehicles, such as robots or cars, aerial vehicles, such as manned or unmanned aerial vehicles (UAVs), the latter also referred to as drones, buildings and other items or devices having embedded therein electronics, software, sensors, actuators, or the like as well as network connectivity that enables these devices to collect and exchange data across an existing network infrastructure. FIG. 1(b) shows an exemplary view of five cells, however, the RANₙ may include more or less such cells, and RANₙ may also include only one base station. FIG. 1(b) shows two users UE₁ and UE₂, also referred to as user equipment, UE, that are in cell 106₂ and that are served by base station gNB₂. Another user UE₃ is shown in cell 106₄ which is served by base station gNB₄. The arrows 108₁, 108₂ and 108₃ schematically represent uplink/downlink connections for transmitting data from a user UE₁, UE₂ and UE₃ to the base stations gNB₂, gNB₄ or for transmitting data from the base stations gNB₂, gNB₄ to the users UE₁, UE₂, UE₃. Further, FIG. 1(b) shows two IoT devices 110₁ and 110₂ in cell 106₄, which may be stationary or mobile devices. The IoT device 110₁ accesses the wireless communication system via the base station gNB₄ to receive and transmit data as schematically represented by arrow 112₁. The IoT device 110₂ accesses the wireless communication system via the user UE₃ as is schematically represented by arrow 112₂. The respective base station gNB₁ to gNB₅ may be connected to the core network 102, e.g. via the S1 interface, via respective backhaul links 114₁ to 114₅, which are schematically represented in FIG. 1(b) by the arrows pointing to “core”. The core network 102 may be connected to one or more external networks. Further, some or all of the respective base station gNB₁ to gNB₅ may connected, e.g. via the S1 or X2 interface or the XN interface in NR, with each other via respective backhaul links 116₁ to 116₅, which are schematically represented in FIG. 1(b) by the arrows pointing to “gNBs”.

For data transmission a physical resource grid may be used. The physical resource grid may comprise a set of resource elements to which various physical channels and physical signals are mapped. For example, the physical channels may include the physical downlink, uplink and sidelink shared channels (PDSCH, PUSCH, PSSCH) carrying user specific data, also referred to as downlink, uplink and sidelink payload data, the physical broadcast channel (PBCH) carrying for example a master information block (MIB) and a system information block (SIB), the physical downlink, uplink and sidelink control channels (PDCCH, PUCCH, PSSCH) carrying for example the downlink control information (DCI), the uplink control information (UCI) and the sidelink control information (SCI). For the uplink, the physical channels may further include the physical random access channel (PRACH or RACH) used by UEs for accessing the network once a UE synchronized and obtained the MIB and SIB. The physical signals may comprise reference signals or symbols (RS), synchronization signals and the like. The resource grid may comprise a frame or radio frame having a certain duration in the time domain and having a given bandwidth in the frequency domain. The frame may have a certain number of subframes of a predefined length, e.g. 1 ms. Each subframe may include one or more slots of 12 or 14 OFDM symbols depending on the cyclic prefix (CP) length. A frame may also consist of a smaller number of OFDM symbols, e.g. when utilizing shortened transmission time intervals (sTTI) or a mini-slot/non-slot-based frame structure comprising just a few OFDM symbols.

The wireless communication system may be any single-tone or multicarrier system using frequency-division multiplexing, like the orthogonal frequency-division multiplexing (OFDM) system, the orthogonal frequency-division multiple access (OFDMA) system, or any other IFFT-based signal with or without CP, e.g. DFT-s-OFDM. Other waveforms, like non-orthogonal waveforms for multiple access, e.g. filter-bank multicarrier (FBMC), generalized frequency division multiplexing (GFDM) or universal filtered multi carrier (UFMC), may be used. The wireless communication system may operate, e.g., in accordance with the LTE-Advanced pro standard or the 5G or NR, New Radio, standard.

The wireless network or communication system depicted in FIG. 1 may by a heterogeneous network having distinct overlaid networks, e.g., a network of macro cells with each macro cell including a macro base station, like base station gNB₁ to gNB₅, and a network of small cell base stations (not shown in FIG. 1), like femto or pico base stations.

In addition to the above described terrestrial wireless network also non-terrestrial wireless communication networks exist including spaceborne transceivers, like satellites, and/or airborne transceivers, like unmanned aircraft systems. The non-terrestrial wireless communication network or system may operate in a similar way as the terrestrial system described above with reference to FIG. 1, for example in accordance with the LTE-Advanced Pro standard or the 5G or NR, new radio, standard.

In mobile communication networks, for example in a network like that described above with reference to FIG. 1, like an LTE or 5G/NR network, there may be UEs that communicate directly with each other over one or more sidelink (SL) channels, e.g., using the PC5 interface. UEs that communicate directly with each other over the sidelink may include vehicles communicating directly with other vehicles (V2V communication), vehicles communicating with other entities of the wireless communication network (V2X communication), for example roadside entities, like traffic lights, traffic signs, or pedestrians. Other UEs may not be vehicular related UEs and may comprise any of the above-mentioned devices. Such devices may also communicate directly with each other (D2D communication) using the SL channels.

When considering two UEs directly communicating with each other over the sidelink, both UEs may be served by the same base station so that the base station may provide sidelink resource allocation configuration or assistance for the UEs. For example, both UEs may be within the coverage area of a base station, like one of the base stations depicted in FIG. 1. This is referred to as an “in-coverage” scenario. Another scenario is referred to as an “out-of-coverage” scenario. It is noted that “out-of-coverage” does not mean that the two UEs are not within one of the cells depicted in FIG. 1, rather, it means that these UEs
may not be connected to a base station, for example, they are not in an RRC connected state, so that the UEs do not receive from the base station any sidelink resource allocation configuration or assistance, and/or
may be connected to the base station, but, for one or more reasons, the base station may not provide sidelink resource allocation configuration or assistance for the UEs, and/or
may be connected to the base station that may not support NR V2X services, e.g. GSM, UMTS, LTE base stations.

When considering two UEs directly communicating with each other over the sidelink, e.g. using the PC5 interface, one of the UEs may also be connected with a BS, and may relay information from the BS to the other UE via the sidelink interface. The relaying may be performed in the same frequency band (in-band-relay) or another frequency band (out-of-band relay) may be used. In the first case, communication on the Uu and on the sidelink may be decoupled using different time slots as in time division duplex, TDD, systems.

It is noted that the information in the above section is only for enhancing the understanding of the background of the invention and therefore it may contain information that does not form conventional technology that is already known to a person of ordinary skill in the art.

### SUMMARY

According to an embodiment, a communication system may have: a data transmission controller; at least a transmitter; and at least a receiver; wherein the transmitter is configured to transmit a first data portion to the receiver by use of a resource portion having a bandwidth and a plurality of time frames in a manner to further increase a redundancy of the first data portion to be transmitted from time frame to time frame of the plurality of time frames, wherein the receiver is configured to analyze the received first data portion and its redundancy to determine a correctly and/or completely and/or sufficiently received first data portion or incorrectly and/or incompletely and/or insufficiently received first data portion and to transmit an ACK signal to the transmitter using said resource portion, when determining the correctly and/or completely and/or sufficiently received first data portion; wherein said resource portion is the same resource portion used for the transmission performed by the transmitter.

Another embodiment may have a gNB or eNB or base station or user equipment forming a transmitter of a communication system, wherein the communication system including a data transmission controller, at least transmitter and at least receiver; wherein the transmitter is configured to transmit a first data portion to the receiver by use of a resource portion having a bandwidth and a plurality of time frames in a manner to further increase a redundancy of the first data portion to be transmitted from time frame to time frame of the plurality of time frames, wherein the receiver is configured to analyze the received first data portion and its redundancy to determine a correctly and/or completely and/or sufficiently received first data portion or incorrectly and/or incompletely and/or insufficiently received first data portion and to transmit an ACK signal to the transmitter using said resource portion, when determining the correctly and/or completely and/or sufficiently received first data portion; wherein said resource portion is the same resource portion used for the transmission performed by the transmitter.

Another embodiment may have a user equipment, gNB or eNB or base station forming a receiver of a communication system, the communication system including a data transmission controller, at least transmitter and at least a receiver, wherein the transmitter is configured to transmit a first data portion to the receiver by use of a resource portion having a bandwidth and a plurality of time frames in a manner to further increase a redundancy of the first data portion to be transmitted from time frame to time frame of the plurality of time frames, wherein the receiver is configured to analyze the received first data portion and its redundancy to determine a correctly and/or completely and/or sufficiently received first data portion or incorrectly and/or incompletely and/or insufficiently received first data portion and to transmit an ACK signal to the transmitter using said resource portion, when determining the correctly and/or completely and/or sufficiently received first data portion; wherein said resource portion is the same resource portion used for the transmission performed by the transmitter.

According to another embodiment, a method for controlling a communication system, including a data transmission controller, a transmitter and a receiver, may have the steps of: transmitting a first data portion to the receiver by use of a resource portion having a bandwidth and a plurality of time frames in a manner to further increase redundancy of the first data portion to be transmitted from time frame to time frame of the plurality of time frames; analyzing the received first data portion and its redundancy to determine a correctly and/or completely and/or sufficiently received first data portion or incorrectly and/or incompletely and/or insufficiently received first data portion; and transmitting an ACK signal to the transmitter using said resource portion, when determining the correctly and/or completely and/or sufficiently received first data portion; wherein said resource portion is the same resource portion used for the transmission performed by the transmitter.

According to another embodiment, a method for transmitting a data portion by use of a communication system, the communication system including a data transmission controller, a transmitter, a receiver, may have the steps of: transmitting a first data portion to the receiver by use of a resource portion having a bandwidth and a plurality of time frames in a manner to further increase a redundancy of the first data portion to be transmitted from time frame to time frame of the plurality of time frames; wherein the receiver is configured to analyze the received first data portion and its redundancy to determine a correctly and/or completely and/or sufficiently received first data portion or incorrectly and/or incompletely and/or insufficiently received first data portion and to transmit an ACK signal to the transmitter using said resource portion, when determining the correctly and/or completely and/or sufficiently received first data portion; wherein said resource portion is the same resource portion used for the transmission performed by the transmitter.

According to another embodiment, a method for receiving a data portion within a communication system, the communication system including an data transmission controller, a transmitter, a receiver, wherein the transmitter is configured to transmit a first data portion of the receiver by use of a resource portion having a bandwidth and a plurality of time frames in a manner to further increase a redundancy of the first data portion to be transmitted from time frame to time frame of the plurality of time frames, may have the steps of: analyzing the received first data portion and its redundancy to determine a correctly and/or completely and/or sufficiently received first data portion or incorrectly and/or incompletely and/or insufficiently received first data portion; and transmitting an ACK signal to the transmitter using said resource portion, when determining the correctly and/or completely and/or sufficiently received first data portion; wherein said resource portion is the same resource portion used for the transmission performed by the transmitter.

Another embodiment may have a non-transitory digital storage medium having a computer program stored thereon to perform the method for controlling a communication system, including a data transmission controller, a transmitter and a receiver, the method having the steps of: transmitting a first data portion to the receiver by use of a resource portion having a bandwidth and a plurality of time frames in a manner to further increase redundancy of the first data portion to be transmitted from time frame to time frame of the plurality of time frames; analyzing the received first data portion and its redundancy to determine a correctly and/or completely and/or sufficiently received first data portion or incorrectly and/or incompletely and/or insufficiently received first data portion; and transmitting an ACK signal to the transmitter using said resource portion, when determining the correctly and/or completely and/or sufficiently received first data portion; wherein said resource portion is the same resource portion used for the transmission performed by the transmitter, when said computer program is run by a computer.

According to an embodiment, a communication system may have: a resource controller; at least a transmitter configured to transmit a second data portion to a receiver by use of a second resource portion having a dynamic staring point and being scheduled after a first resource portion by use of which a first data portion is transmitted within the communication network by the communication system; and at least the receiver; wherein the resource controller is configured to assign the second resource portion and the dynamic starting point; wherein the transmitter prepares the transmission of the second data portion and/or the receiver the receipt of the second data portion for the dynamic starting point in accordance to the assigned second resource portion and the dynamic starting point and starts the transmission and/or the receipt as a response to an event.

Another embodiment may have a controller of a communication system including a resource controller and at least a transmitter configured to transmit a second data portion to a receiver by use of a second resource portion having a dynamic starting point and being scheduled after a first resource portion by use of which a first data portion is transmitted within the communication network used by the communication system, and at least the receiver, wherein the resource controller is configured to assign the second resource portion and the dynamic starting point; wherein the transmitter prepares the transmission of the second data portion and/or the receiver the receipt of the second data portion for the dynamic starting point and starts the transmission and/or the receipt as a response to an event.

Another embodiment may have a transmitter of a communication system, the communication system including a resource controller and a transmitter configured to transmit a second data portion to a receiver by use of a second resource portion having a dynamic starting point and being scheduled after the first resource portion by use of which a first data portion is transmitted within the communication network used by the communication system, and at least the receiver, wherein the resource controller is configured to assign the second resource portion and the dynamic starting point; wherein the transmitter is configured to prepare the transmission of the second data portion for the dynamic starting point and to start the transmission as a response to an event.

Another embodiment may have a receiver of a communication system, the communication system including a resource controller and a transmitter configured to transmit a second data portion to a receiver by use of a second resource portion having a dynamic starting point and being scheduled after the first resource portion by use of which a first data portion is transmitted within the communication network used by the communication system, and at least the receiver, wherein the resource controller is configured to assign the second resource portion and the dynamic starting point; wherein the receiver is configured to prepare the receipt of the second data portion for the dynamic starting point and to start the receipt as a response to an event.

Another embodiment may have a method for resource controlling within a communication system, including a transmitter configured to transmit a second data portion to a receiver by use of a second resource portion having a dynamic starting point and being scheduled after the first resource portion by use of which a first data portion is transmitted within the second communication network used by the communication system; and at least the receiver, wherein the transmitter prepares the transmission of the second data portion and/or the receiver the receipt of the second data portion for the dynamic starting point and starts the transmission and/or receipt as a response to an event, the method having the steps assigning the second resource portion and the dynamic starting point.

According to another embodiment, a method for transmitting within a communication system, the communication system including a resource controller which is configured to assign a second resource portion and a dynamic starting point, may have the steps of: preparing the transmission for the dynamic starting point; starting the transmission as a response to an event; and transmitting a second data portion to a receiver by use of a second resource portion having the dynamic starting point and being scheduled after the first resource portion by use of which a first data portion is transmitted within the communication network used by the communication system.

According to another embodiment, a method for receiving within a communication system, the communication system including a resource controller which is configured to assign a second resource portion and a dynamic starting point, may have the steps of: preparing the receipt for the dynamic starting point; starting the receipt as a response to an event; and receiving a second data portion by use of a second resource portion having the dynamic starting point and being scheduled after the first resource portion by use of which a first data portion is transmitted within the communication network used by the communication system.

Another embodiment may have a non-transitory digital storage medium having a computer program stored thereon to perform the method for resource controlling within a communication system, including a transmitter configured to transmit a second data portion to a receiver by use of a second resource portion having a dynamic starting point and being scheduled after the first resource portion by use of which a first data portion is transmitted within the second communication network used by the communication system; and at least the receiver, wherein the transmitter prepares the transmission of the second data portion and/or the receiver the receipt of the second data portion for the dynamic starting point and starts the transmission and/or receipt as a response to an event, the method having the steps assigning the second resource portion and the dynamic starting point, when said computer program is run by a computer.

### BRIEF DESCRIPTION OF THE DRAWINGS

Embodiments of the present invention will be detailed subsequently referring to the appended drawings, in which:

FIGS. 1a and 1b shows a schematic representation of an example of a wireless communication system;

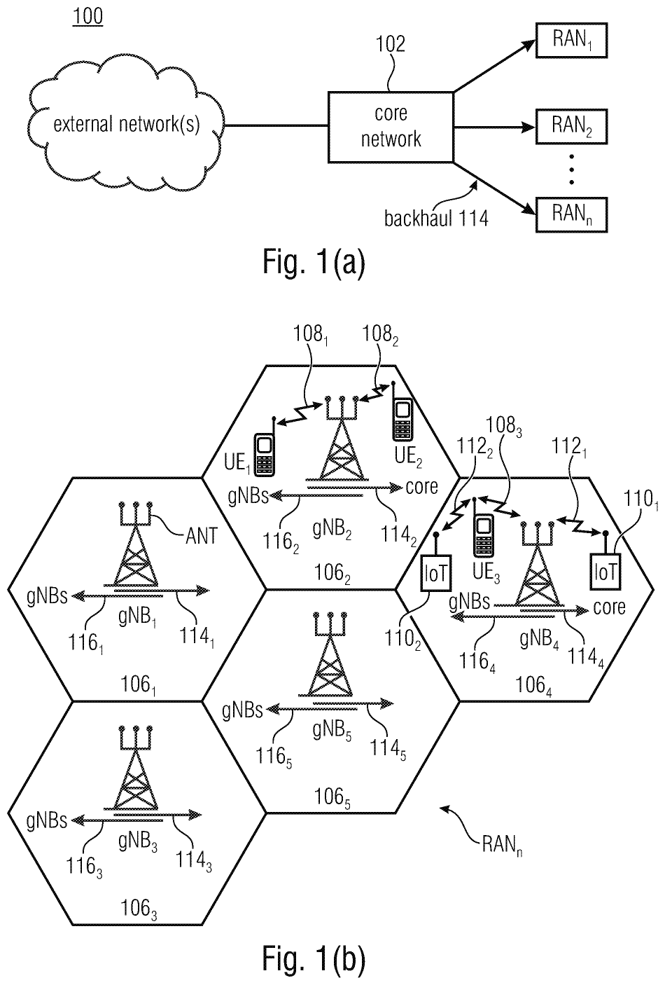

FIGS. 2a and 2b show schematic representations of a resource block for illustrating a full duplex feedback transmission according to different embodiments of the first aspect;

FIG. 3 schematically shows a diagram for illustrating their probability of misdetection to describe their benefits of embodiments; and

FIG. 4 shows a schematic resource diagram for illustrating the principle of dynamic starting point grants/scheduling assignments according to further embodiments of a second aspect.

### DETAILED DESCRIPTION OF THE INVENTION

Embodiments of the present invention are now described in more detail with reference to their accompanying drawings in which the same or similar elements have the same reference signs assigned.

For next-generation mobile communication systems, rate-less HARQ mechanisms are discussed to provide a good trade-off between spectral efficiency/energy, reliability and latency. In the rate-less HARQ approach, the transmitter, e.g. gNB, transmits constantly more redundancy for a data packet until it receives an ACK which indicates a successful reception at the receiver. This causes the transmitter to stop and proceed with other transmissions. However, in current 5G systems which assume a half-duplex gNB which operates in TDD or FDD schemes, these rate-less HARQ approaches come with a high UL control channel overhead. In particular, the gNB has to reserve many physical uplink control channel (PUCCH) resources distributed over the duration of the transmission since it does not know when to expect the ACK from the receiver. Furthermore, the gNB wants to reduce the latency till the next PUCCH opportunity to a minimum in order to reduce the overhead of unnecessary downlink transmissions. Sharing these resources with other UL transmissions for other UEs would degrade the reliability of PUCCH in case of an collision. Hence, this overhead poses a severe limitation on the practicality of rate-less HARQ schemes.

Full Duplex Transmission—Communication System

According to embodiments, the communication system comprises a data transmission controller, at least a transmitter (like the transmitter of base station) and at least a receiver (like the receiver of a UE). The transmitter is configured to transmit a first data portion to the receiver by use of a resource portion comprising a bandwidth and a plurality of time frames in a manner to further increase a redundancy of the first data portion to be transmitted from time frame to time frame of the plurality of time frames, wherein the receiver is configured to analyze the received first data portion and its redundancy to determine a correctly and/or completely and/or sufficiently received first data portion or incorrectly and/or incompletely and/or insufficiently received first data portion and to transmit an ACK signal to the transmitter using said resource portion, when determining the correctly and/or completely and/or sufficiently received first data portion.

Full Duplex Feedback Transmission—gNB, eNB, Based Station or User Equipment

Another embodiment refers to a gNB, eNB, base station or user equipment forming a transmitter of the communication system. Here, the transmitter is configured to transmit a first data portion to the receiver by use of a resource portion comprising a bandwidth and a plurality of time frames in a manner to further increase a redundancy of the first data portion to be transmitted from time frame to time frame of the plurality of time frames, wherein the receiver is configured to analyze the received first data portion and its redundancy to determine a correctly and/or completely and/or sufficiently received first data portion or incorrectly and/or incompletely and/or insufficiently received first data portion and to transmit an ACK signal to the transmitter using said resource portion, when determining the correctly and/or completely and/or sufficiently received first data portion.

According to further embodiments, user equipment, gNB, eNB or base station forming a receiver of the communication system. Here, the transmitter is configured to transmit a first data portion to the receiver by use of a resource portion comprising a bandwidth and a plurality of time frames in a manner to further increase a redundancy of the first data portion to be transmitted from time frame to time frame of the plurality of time frames, wherein the receiver is configured to analyze the received first data portion and its redundancy to determine a correctly and/or completely and/or sufficiently received first data portion or incorrectly and/or incompletely and/or insufficiently received first data portion and to transmit an ACK signal to the transmitter using said resource portion, when determining the correctly and/or completely and/or sufficiently received first data portion.

Embodiments of this aspect are based on the principle that a communication concept within which the receiver performing a HARQ comparable process transmits its feedback information, e.g., the ACK signal by use of the same resources used for the transmission for the transmitter to the receiver to enable a “fast HARQ—ACK transmission for rate-less HARQ. Here, only a limited full duplex capability of the transmitter is used. Note, that this principle is not limited to HARQ process or rate-less HARQ processes. For example, this principle can be used for conventional HARQ process comprising signals like an ACK and a NACK. Furthermore, this process does not require other HARQ mechanisms, but enables to exchange control data so as to improve spectral efficiency, spectral energy, reliability and low intensity.

Full Duplex Feedback Transmission—Further Aspects

According to embodiments, the transmission controller is configured to stop the transmitting of the first data portion in response to the received ACK signal. This improves the efficiency of an entire communication system, since due to the transmission of the ACK the receiver can stop to increase the redundancy of the transmission of the first data portion so as to enable the usage of the further resources.

According to further embodiments, the received ACK is transmitted using a predetermined time frame of the plurality of time frames belonging to the resource portion. According to further embodiments, the plurality of time frames belonging to the resource portion comprise a plurality of predetermined time frames. The usage of predetermined time frames is beneficial, since these can be known for every user within the communication system and then the different users just listen for the predetermined time frame. This approach enables to save energy. According to embodiments, the predetermined time frames are periodically arranged within the resource portion, wherein the periodicity is preconfigured or configured by a gNB. According to further embodiments, the predetermined time frames within the resource portion are explicitly indicated by a gNB, e.g. by using a bitmap or a periodicity and a starting offset. According to further embodiments, the predetermined time frames within the resource portion are overlaying specific reference signals, such as Demodulation Reference Signals, DMRS. According to the further embodiment, the positions of the predetermined time-frames may not be signaled explicitly but derived implicitly from the specific reference signals, such as Demodulation Reference Signals, DMRS.

According to further embodiments, the ACK signal is transmitted in a manner, such that one or more guard bands are arranged next to the ACK signal. According to embodiments, the guard bands may be configured by the eNB or gNB.

According to embodiments, the ACK signal is transmitted as predetermined sequence, as Zadoff-Chu sequence, and/or a sequence, a cross correlation of the sequence and the overlaid reference signal, e.g. DMRS, is resulting to zero.

Full Duplex Feedback Transmission—Methods

Further embodiments provide a method for controlling a communication system, comprising a data transmission controller, a transmitter and a receiver, the method comprising the following steps: transmitting a first data portion to the receiver by use of a resource portion comprising a bandwidth and a plurality of time frames in a manner to further increase redundancy of the first data portion to be transmitted from time frame to time frame of the plurality of time frames; analyzing the received first data portion and its redundancy to determine a correctly and/or completely and/or sufficiently received first data portion or incorrectly and/or incompletely and/or insufficiently received first data portion; and transmitting an ACK signal to the transmitter using said resource portion, when determining the correctly and/or completely and/or sufficiently received first data portion.

Another embodiment provides a method for transmitting a data portion. Here, the method comprises the step transmitting a first data portion to the receiver by use of a resource portion comprising a bandwidth and a plurality of time frames in a manner to further increase a redundancy of the first data portion to be transmitted from time frame to time frame of the plurality of time frames.

Another embodiment provides a method for receiving a data portion. Here, the method comprises the following steps: analyzing the received first data portion and its redundancy to determine a correctly and/or completely and/or sufficiently received first data portion or incorrectly and/or incompletely and/or insufficiently received first data portion; and transmitting an ACK signal to the transmitter using said resource portion, when determining the correctly and/or completely and/or sufficiently received first data portion.

Of course, aspects discussed in the context of the communication system or an apparatus of the communication system are also to be used in combination with the corresponding method. According to further embodiments, the method may be computer implemented. Therefore, another embodiment provides a computer digital storage medium having stored there on a computer program for performing the method.

Dynamic Starting Point—Communication System

An embodiment of this aspect provides a communication system comprising a resource controller and at least a transmitter. The transmitter is configured to transmit a second data portion to a receiver by use of a second resource portion having a dynamic staring point and being scheduled after a first resource portion by use of which a first data portion is transmitted within the communication network by the communication system. The resource controller is configured to assign the second resource portion and the dynamic starting point. The transmitter (and/or the receiver) prepares the transmission for the dynamic starting point in accordance to the assigned second resource portion and the dynamic starting point and starts a transmission (receipt) as a response to an event.

Dynamic Starting Point—Controller

Another embodiment refers to a controller for the above-described system. Here, the resource controller is configured to assign the second resource portion and the dynamic starting point, such that the transmitter (and/or the receiver as well) can prepare the transmission/receipt for the dynamic starting point and starts a transmission/receipt as a response to an event.

Dynamic Starting Point—Transmitter

Another embodiment refers to a transmitter of the above-discussed communication system. The transmitter is configured to prepare the transmission for the dynamic starting point and to start the transmission as a response to an event.

Note, the transmitter may be a transmitter of a user equipment or a base station or a gNB or eNB.

Dynamic Starting Point—Receiver

Another embodiment refers to a receiver of the above-discussed communication system. The receiver is configured to prepare the receipt for the dynamic starting point and to start the receipt of the data portion as a response to an event.

Note, the receiver may be a receiver of a user equipment or a base station or a gNB or eNB.

Dynamic Starting Point—Methods

According to embodiments, a method for resource controlling is formed. The method comprises the basic step of assigning the second resource portion and the dynamic starting point.

Another method refers to the transmitting within the communication system. This method comprises the basic steps transmitting a second data portion in a receiver by use of a second resource portion having the dynamic starting point and being scheduled after the first resource portion by use of which a first data portion is transmitted within the communication network used by the communication system; preparing the transmission for the dynamic starting point; and starting the transmission as a response to an event. Here, it should be noted that especially the step of transmitting is according to embodiments, performed after the step of starting.

Another method refers to the receiving within a communication system. This method comprises the basic steps preparing the receipt for the dynamic starting point; starting the receipt as a response to an event; and receiving a second data portion by use of a second resource portion having the dynamic starting point and being scheduled after the first resource portion by use of which a first data portion is transmitted within the communication network used by the communication system.

Please note, that the methods can be performed by use of a computer. Therefore, another embodiment refers to a computer readable digital storage medium having stored there on a computer program having a program code for performing one of the above-discussed methods.

Embodiments of this aspect enable to grant/schedule resources for a transmitter and/or a receiver within a resource portion, which is at the moment not free, e.g., used by another transmitter/receiver or used by itself. Thus, the transmitter as well as the receiver can prepare for the transmission/receipt and starts the transmission/receipt when receiving a starting trigger (also referred to as event). This is beneficial, since by such an approach scheduling dynamic resources is more easy. For example, when using the concept of full duplex feedback transmission, other transmitter/receiver/pair or another transmission can start immediately after the previous transmission. Of course, this concept is also applicable to other transmissions concepts, e.g., when the transmission rate varies, so that it is unknown when the previous transmission will be completed.

Dynamic Starting Point—Further Aspects

According to embodiments the event may comprise a signal provided by the resource controller. According to further embodiments, the event can comprise an ACK signal indicating the receipt of the first data portion. Here, the ACK signal may be transmitted using said first resource portions. Using the ACK as event is beneficial since said ACK is available when using full duplex feedback transmission. The transmitter and/or the receiver may—according to embodiments—start listening beginning with the earliest starting point, e.g. in order to determine the ACK signal or (in general) the event. Note, the listening may be performed for a previously configured duration.

According to further embodiments, the event may comprise a signal power being below a predetermined threshold and/or being below a predetermined threshold for a predetermined time period. In other words, there are different variants of events causing the transmission of the second data portion.

According to embodiments the second data portion is directly transmitted after the first data portion or directly transmitted after a guard period for the first data portion. This has the advantage, that the second data portion can be transmitted directly subsequent to the first data portion.

According to embodiments, the earliest starting point is received within an information (e.g. resource allocation massage) provided by the resource controller.

Full Duplex Feedback Transmission—Embodiments

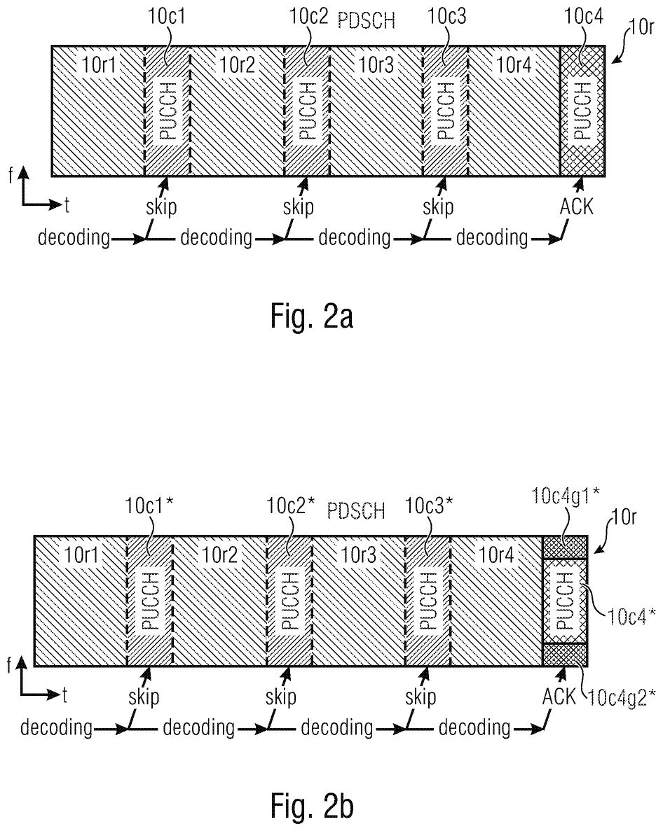

Embodiments for the full duplex feedback transmission will be discussed referring to FIGS. 2a and 2b. Here, also optional features may be discussed.

FIG. 2a shows a resource portion 10 which may have a frequency dimension (cf. f) and a time dimension (cf. t). The resource portion is marked by 10r and comprises a plurality of sub portions 10r1, 10r2 and 10r3. These portions 10r1 to 10r3 may all use the complete frequency band belonging to the resource portion 10r. in the portions 10r1 to 10r3 may be sequentially arranged in the time domain. Advantageously, but not necessarily, the portions 10r1 to 10r3 may be arranged without a gap in between when seen in a time domain. However, it should be noted that the shape with regard to the frequency domain and the time domain may differ, e.g., that the bandwidth of the frequency portion varies on the used frequencies vary over the time or that not a continuous time portion is used.

According to embodiments, at the end of each time frame 10r1 to 10r3 a so-called control frame 10c1 to 10c4 may be arranged. This control frame 10c1 to 10c4 may be arranged at the end, i.e., as part of the portion 10r1 to 10r3 or between the portions 10r1 to 10r3.

These control portions 10c1, 10c2 and 10c3 have a position, but are not used as control portions. This is illustrated by the schematic. Consequently, the entire resource portion 10r1, 10r2, 10r3 and 10r4 including the portions 10c1, 10c2 and 10c3 can be used for the downlink, i.e., the transition of the payload.

According to this aspect, the transmitter transmits the first data portion to the receiver by use of the resource portion comprising the elements 10r1, 10c1, 10r2, 10c2, 10r3, 10c3 and 10r4. During this transmission, especially along the time domain, the redundancy of the first data portion to be transmitted is increased from frame to frame (i.e., from 10r1 to 10r2 to 10r3 to 10r4). This so-called rate-less HARQ mechanism is performed up to the point of time, when a stop command is received. Here, the stop command or, in general control commands are transmitted within the same resource portion. For example, the receiver of the data portion transmits an ACK signal using the portion 10c4 so as to indicate a successful receipt of the data portion. In order to find out, whether the entire data portion has been received correctly, it continuously decodes the sub portions 10r1, 10r2, 10r3 and 10r4 and sends the ACK signal after determining, a successfully/completely/sufficiently receipt. For example, when a receiver receives the portion completely to a previous point of time it can send the ACK signal or the time frame marked by 10c4 within the same resource portion. According to embodiments, the control portions 10c1, 10c2 to 10c3 can be used. The usage of predetermined positions is advantageous, since this improves the detection of the ACK signal within the same resource portion, especially for the transmitter.

As illustrated by FIG. 2a, the receiver, here a UE transmits the ACK in a PUCCH 10c4 using only its own downlink resource (fully or partially). This does not disturb any other UE since the HARQ transmission only interferes with the UEs own downlink transmission which is anyway decoded correctly or predicted to be decoded correctly at the time of the PUCCH transmission 10c4.

As indicated above, only a part of the entire downlink resources 10r are used for transmitting the control signal/ACK signal. As illustrated by FIG. 2a, the partitioning is performed in the time domain, wherein predetermined positions (here periodically arranged control portions 10c1 to 10c4) may be used.

According to a further embodiment, as illustrated by FIG. 2b, just a frequency portion within 10c4 is used for transmitting the ACK. Beside this frequency portion marked by 10c4* one or two guard bands 10c4 t1* and tc4g2* are arranged. Of course, these guard bands 10c4g1* and 10c4g2* can also be arranged, when another control portion, like 10c1* or 10c2* or 10c3* are used. This PUCCH guard band has the following advantages: when transmitting the HARQ-ACK in the PUCCH, the UE causes interference for UE receiving data on neighboring frequency resources. Hence, the UE may be configured with guard bands around the actual PUCCH transmission such that the signal power stays in the spectrum of the PDSCH.

According to embodiments, a correlation-based HARQ-ACK transmission can be used. In order to reduce the complexity of the gNB, it is proposed only to transmit an ACK signal in the PUCCH 10r. The ACK is transmitted using a (known) signal sequence which is easily detectable at the gNB side by using a correlation. For example, the Zadoff-Chu sequence which has the property that the cross-correlation with other Zadoff-Chu sequences with another cyclic shift results to zero. This is important in case other UEs of the same or neighboring cells also perform a similar ACK transmission on the same resource. In this scenario, the interference by these is minimized if the gNB(s) configure the different UEs with different cyclic shifts.

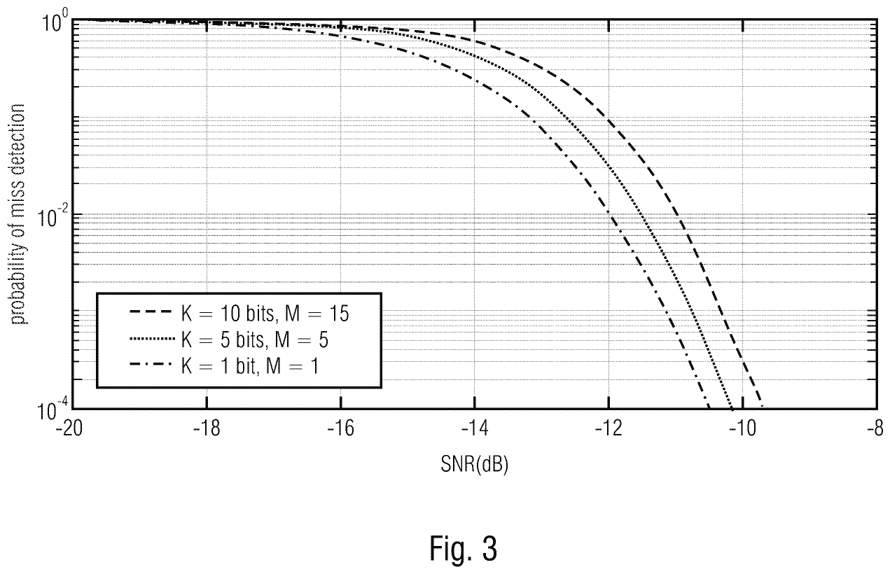

FIG. 3 shows the misdetection probability of CP-DSSS (cyclical preference-direct sequence spread spectrum) which are constructed based on ZC sequences. As clearly visible, a robust detection of these sequences is possible even at very low SNRs, such as −10 dB, with high interference from other sources, e.g. self-interference in the full-duplex scenario. Hence, the gNB does not have to fully compensate its own interference to enable a robust detection of the HARQ-ACK.

According to further embodiments, some transmission slots 10c1 to 10c4 are predetermined/preconfigured, as already discussed above. It should be mentioned that the usage of the transmission slots is optional. To reduce power consumption at the gNB side, the gNB may configure the UE with specific PUCCH resources with a periodicity. In this case, the UE would be allowed to transmit HARQ-ACK only in one of these PUCCH resources such that the gNB has to perform the scanning only for these configured resources.

Dynamic Starting Point—Embodiments

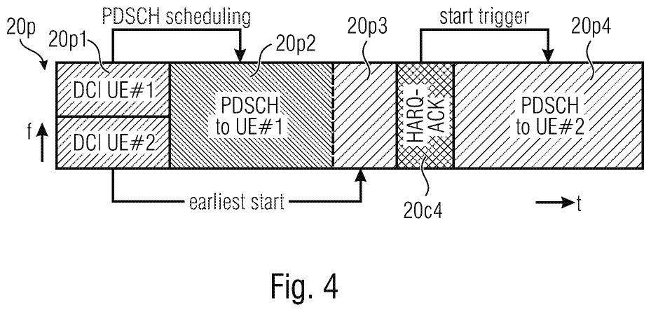

Below, with respect to FIG. 4, the principle of using a dynamic starting point (dynamic starting point grants/scheduling assignments) will be discussed. Before discussing this principle, which can be used in general for different scenarios, a configuration within which the dynamic starting point can be applied is discussed.

In case a rate-less HARQ scheme as discussed with respect to FIGS. 2a and 2b is employed, the time when the transmission, e.g., to the first UE #1 will stop is not known before. Hence, scheduling another UE #2 directly after the end of the transmission of UE #1 is a challenge.

Background thereof is that the UEs, e.g., UE #2 naturally need time to process control information to receive or send a transmission.

To solve this issue, it is proposed to use dynamic starting point grants/scheduling assignments. This principle is illustrated by FIG. 4.

FIG. 4 shows a resource portion 20p. it is assumed that the entire resource portion 20p has a constant frequency portion, wherein this assumption is just made for simplification to explain the principle. Expressed in other words, this means that the frequency and/or in general the frequency portion can vary over time. The resource portion 20p comprises a plurality of sub portions arranged in the time domain t. Within the first time frame marked by 20p1, two different dynamic control information are transmitted to UE #1 and UE #2. For UE #1, the PDSCH portion 20p2 is scheduled. This portion 20p2 is arranged subsequently to 20p1. By use of the dynamic control information DCI UE #2, a dynamic starting point (cf. portion 20p3 for UE #2) is set. This dynamic starting point represents the earliest starting point for UE #2. As illustrated by the broken lines, at the point of time when scheduling the PDSCH to UE #1 and PDSCH to UE #2 the exact starting point is not known, but is predicted to be somewhere within the time frame 20p3. The transmission to UE #2 starts with a trigger. According to embodiments, the trigger can be the HARQ-ACK signal as discussed in context of the embodiment of FIG. 2. This ACK signal as event for starting the transmission to UE #2 is marked by the reference numeral 20c4. As illustrated, the start trigger for PDSCH to UE #2 marked by the reference numeral 20p4.

In difference to a control message which gives a conventional grant or scheduling assignment, the dynamic starting point grant/scheduling assignment specifies only the earliest starting point in time. The remaining information may also be different or may be the same as in a conventional grant/scheduling assignment, e.g. frequency resource, MCS, HARQ process ID, NDI, etc.

The UE, here UE #2 receiving a dynamic starting point grant/scheduling assignment prepares for receiving or transmitting at earliest at the specified starting point. There are a plurality of different events for determining the actual stating point.

According to a first option, a special sequence transmitted by the gNB can be used. The gNB transmits a preconfigured signal to indicate the starting point to the UE with the dynamic starting point grant. The UE starts scanning for this signal at the EARLIEST starting point specified in the grant/scheduling assignment. The duration of the scanning procedure is up to detection of the preconfigured signal and/or a configured or preconfigured duration.

According to a second option, the ACK signal (cf. embodiment of FIG. 2) can be used. This HARQ-ACK detection may be performed as follows: the UE performs the same scanning procedure as described above. However, the starting signal is not transmitted by the gNB but by the UE receiving data using a rate-less HARQ procedure. This may be the HARQ-ACK signal that this UE transmits anyways to the gNB to indicate successful reception of the data.

According to a third option, a so-called LBT (listening before transmitting) procedure can be performed. The UE performs an LBT procedure. For example, it starts measuring the received signal power on the frequency resource specified in the grant/scheduling assignment. Once, the received power drops below a preconfigured threshold for a certain duration the UE considers the previous transmission to be finished and starts its own reception/transmission.

Although some aspects have been described in the context of an apparatus, it is clear that these aspects also represent a description of the corresponding method, where a block or device corresponds to a method step or a feature of a method step. Analogously, aspects described in the context of a method step also represent a description of a corresponding block or item or feature of a corresponding apparatus. Some or all of the method steps may be executed by (or using) a hardware apparatus, like for example, a microprocessor, a programmable computer or an electronic circuit. In some embodiments, some one or more of the most important method steps may be executed by such an apparatus.

Depending on certain implementation requirements, embodiments of the invention can be implemented in hardware or in software. The implementation can be performed using a digital storage medium, for example a floppy disk, a DVD, a Blu-Ray, a CD, a ROM, a PROM, an EPROM, an EEPROM or a FLASH memory, having electronically readable control signals stored thereon, which cooperate (or are capable of cooperating) with a programmable computer system such that the respective method is performed. Therefore, the digital storage medium may be computer readable.

Some embodiments according to the invention comprise a data carrier having electronically readable control signals, which are capable of cooperating with a programmable computer system, such that one of the methods described herein is performed.

Generally, embodiments of the present invention can be implemented as a computer program product with a program code, the program code being operative for performing one of the methods when the computer program product runs on a computer. The program code may for example be stored on a machine readable carrier.

Other embodiments comprise the computer program for performing one of the methods described herein, stored on a machine readable carrier.

In other words, an embodiment of the inventive method is, therefore, a computer program having a program code for performing one of the methods described herein, when the computer program runs on a computer.

A further embodiment of the inventive methods is, therefore, a data carrier (or a digital storage medium, or a computer-readable medium) comprising, recorded thereon, the computer program for performing one of the methods described herein. The data carrier, the digital storage medium or the recorded medium are typically tangible and/or non-transitionary.

A further embodiment of the inventive method is, therefore, a data stream or a sequence of signals representing the computer program for performing one of the methods described herein. The data stream or the sequence of signals may for example be configured to be transferred via a data communication connection, for example via the Internet.

A further embodiment comprises a processing means, for example a computer, or a programmable logic device, configured to or adapted to perform one of the methods described herein.

A further embodiment comprises a computer having installed thereon the computer program for performing one of the methods described herein.

A further embodiment according to the invention comprises an apparatus or a system configured to transfer (for example, electronically or optically) a computer program for performing one of the methods described herein to a receiver. The receiver may, for example, be a computer, a mobile device, a memory device or the like. The apparatus or system may, for example, comprise a file server for transferring the computer program to the receiver.

In some embodiments, a programmable logic device (for example a field programmable gate array) may be used to perform some or all of the functionalities of the methods described herein. In some embodiments, a field programmable gate array may cooperate with a microprocessor in order to perform one of the methods described herein. Generally, the methods are performed by any hardware apparatus.

While this invention has been described in terms of several advantageous embodiments, there are alterations, permutations, and equivalents, which fall within the scope of this invention. It should also be noted that there are many alternative ways of implementing the methods and compositions of the present invention. It is therefore intended that the following appended claims be interpreted as including all such alterations, permutations, and equivalents as fall within the true spirit and scope of the present invention.

### PUBLICATIONS

A. Aminjavaheri, A. R.-B. (2018). Underlay Control Signaling for Ultra-Reliable Low-Latency IoT Communications. 2018 IEEE International Conference on Communications Workshops (ICC Workshops). Kansas City, Mo.

1.-15. (canceled)

16. Communication system, comprising:
a resource controller;
at least a transmitter configured to transmit a second data portion to a receiver by use of a second resource portion comprising a dynamic staring point and being scheduled after a first resource portion by use of which a first data portion is transmitted within the communication network by the communication system; and
at least the receiver;
wherein the resource controller is configured to assign the second resource portion and the dynamic starting point;
wherein the transmitter prepares the transmission of the second data portion and/or the receiver the receipt of the second data portion for the dynamic starting point in accordance to the assigned second resource portion and the dynamic starting point and starts the transmission and/or the receipt as a response to an event.

17. Communication system according to claim 16, wherein the event comprises a signal provided by the resource controller.

18. Communication system to claim 16, wherein the event comprises an ACK signal indicating the receipt of the first data portion.

19. Communication system according to claim 16, wherein the transmitter and/or the receiver starts listening for the event beginning with the earliest starting point.

20. Communication system according to claim 19, wherein the listening is performed for a previously configured duration.

21. Communication system according to claim 19, wherein the earliest starting point is received within a resource allocation message provided by the resource controller.

22. Communication system according to claim 21, wherein the ACK signal is transmitted using said first resource portions.

23. Communication system according to claim 22, wherein the event comprises a signal power being below a predetermined threshold and/or being below a predetermined threshold for a predetermined time period.

24. Communication system according to claim 23, wherein the second data portion is directly transmitted after the first data portion or directly transmitted after a guard period for the first data portion.

25. Controller of a communication system comprising a resource controller and at least a transmitter configured to transmit a second data portion to a receiver by use of a second resource portion comprising a dynamic starting point and being scheduled after a first resource portion by use of which a first data portion is transmitted within the communication network used by the communication system, and at least the receiver,
wherein the resource controller is configured to assign the second resource portion and the dynamic starting point;
wherein the transmitter prepares the transmission of the second data portion and/or the receiver the receipt of the second data portion for the dynamic starting point and starts the transmission and/or the receipt as a response to an event.

26. Transmitter of a communication system, the communication system comprising a resource controller and a transmitter configured to transmit a second data portion to a receiver by use of a second resource portion comprising a dynamic starting point and being scheduled after the first resource portion by use of which a first data portion is transmitted within the communication network used by the communication system, and at least the receiver, wherein the resource controller is configured to assign the second resource portion and the dynamic starting point;
wherein the transmitter is configured to prepare the transmission of the second data portion for the dynamic starting point and to start the transmission as a response to an event.

27. Transmitter according to claim 26, wherein the transmitter is a transmitter of a user equipment, base station, gNB or eNB.

28. Receiver of a communication system, the communication system comprising a resource controller and a transmitter configured to transmit a second data portion to a receiver by use of a second resource portion comprising a dynamic starting point and being scheduled after the first resource portion by use of which a first data portion is transmitted within the communication network used by the communication system, and at least the receiver, wherein the resource controller is configured to assign the second resource portion and the dynamic starting point;
wherein the receiver is configured to prepare the receipt of the second data portion for the dynamic starting point and to start the receipt as a response to an event.

29. Receiver according to claim 28, wherein the receiver is a receiver of a user equipment, base station, gNB or eNB.

30. Method for resource controlling within a communication system, comprising a transmitter configured to transmit a second data portion to a receiver by use of a second resource portion comprising a dynamic starting point and being scheduled after the first resource portion by use of which a first data portion is transmitted within the second communication network used by the communication system; and at least the receiver, wherein the transmitter prepares the transmission of the second data portion and/or the receiver the receipt of the second data portion for the dynamic starting point and starts the transmission and/or receipt as a response to an event, the method comprising assigning the second resource portion and the dynamic starting point.

31. Method for transmitting within a communication system, the communication system comprising a resource controller which is configured to assign a second resource portion and a dynamic starting point, the method comprising:
preparing the transmission for the dynamic starting point;
starting the transmission as a response to an event; and
transmitting a second data portion to a receiver by use of a second resource portion comprising the dynamic starting point and being scheduled after the first resource portion by use of which a first data portion is transmitted within the communication network used by the communication system.

32. Method for receiving within a communication system, the communication system comprising a resource controller which is configured to assign a second resource portion and a dynamic starting point, the method comprising:
preparing the receipt for the dynamic starting point;
starting the receipt as a response to an event; and
receiving a second data portion by use of a second resource portion comprising the dynamic starting point and being scheduled after the first resource portion by use of which a first data portion is transmitted within the communication network used by the communication system.

33. (canceled)
